(19) United States
(12) Patent Application Publication
(10) Pub. No.: US 2024/0320876 A1
(43) Pub. Date: Sep. 26, 2024

(54) IMAGE PROCESSING APPARATUS FOR COMBINING A CAPTURED IMAGE AND A VIRTUAL IMAGE, METHOD FOR THE SAME, AND STORAGE MEDIUM

(71) Applicant: CANON KABUSHIKI KAISHA, Tokyo (JP)

(72) Inventor: AKIHITO TAKETANI, Tokyo (JP)

(21) Appl. No.: 18/736,112

(22) Filed: Jun. 6, 2024

Related U.S. Application Data
(63) Continuation of application No. PCT/JP2022/043289, filed on Nov. 24, 2022.

(30) Foreign Application Priority Data
Dec. 15, 2021 (JP) 2021-203552

(51) Int. Cl. G06T 11/00; G06F 3/14; H04N 9/75

(52) U.S. Cl. CPC G06T 11/00; G06F 3/14; G06T 2210/62; H04N 9/75

(57) ABSTRACT

An image processing apparatus includes an acquisition unit configured to acquire a real image captured by an image capturing device and output the real image, a generation unit configured to receive the real image output from the acquisition unit, generate a virtual image, output the virtual image, and output the received real image or a converted image of the real image, a synthesis unit configured to combine the real image output from the acquisition unit, the virtual image output from the generation unit, and the real image or the converted image output from the generation unit, and a display control unit configured to display an image synthesized by the synthesis unit on a display device, wherein the generation unit changes a delay time of the real image in the image displayed on the display device depending on whether to output the real image or the converted image.

### CROSS-REFERENCE TO RELATED APPLICATIONS

This application is a Continuation of International Patent Application No. PCT/JP2022/043289, filed Nov. 24, 2022, which claims the benefit of Japanese Patent Application No. 2021-203552, filed Dec. 15, 2021, both of which are hereby incorporated by reference herein in their entirety.

### TECHNICAL FIELD

The present invention relates to a technique for combining a captured image and a virtual image and displaying the combined image.

### BACKGROUND ART

A mixed reality (MR) technique and an augmented reality (AR) technique have recently been proposed as a technique for seamlessly merging a real space and a virtual space in real time. One of such known techniques uses a video see-through head mount display (HMD). This technique allows an HMD user to capture an image that substantially matches the image observed from the HMD user’ eye position using, for example, a video camera, and to observe an image in which computer graphics (CGs) are superimposed on the captured image through an HMD internal panel.

This configuration has the issue of a delay of the image displayed on the HMD to exert adverse effects, such as dizziness or discomfort, on the user. Examples of the cause of the delay include transmission of the image and processing for drawing CGs. Accordingly, efforts have been made to solve the issues by devising methods for transmission and processing.

### CITATION LIST

### Patent Literature

PTL 1 Japanese Patent No. 4847192

The typical video see-through method involves capturing a real image with an HMD, transmitting the captured image to an external device, superimposing CGs generated by signal processing on the real image, and then transmitting the combined image back to the HMD for display. The transmission and processing cause a delay in the displayed image.

A technique is known to display a captured real image on the HMD with minimal processing and to combine separately processed CGs with the image. However, this configuration decreases the delay of the real image but causes another issue of time difference from the delay of CGs, which is undesirable in some use cases.

PTL 1 proposes a method of selecting a method for transmitting a real image to a CG drawing unit, superimposing the real image on the CGs, and transmitting the superimposed image back to the HMD or a method for combining a real image that is displayed on the HMD through a shortest path with separately generated CGs in the HMD. However, this method requires path switching, status monitoring, and communication, which complicates the configuration.

### SUMMARY OF INVENTION

In an aspect of the present invention, an image processing apparatus includes an acquisition unit configured to acquire a real image captured by an image capturing device and output the real image; a generation unit configured to receive the real image output from the acquisition unit, generate a virtual image, output the virtual image, and output the received real image or a converted image of the real image; a synthesis unit configured to combine the real image output from the acquisition unit, the virtual image output from the generation unit, and the real image or the converted image output from the generation unit; and a display control unit configured to display an image synthesized by the synthesis unit on a display device, wherein the generation unit changes a delay time of the real image in the image displayed on the display device depending on whether to output the real image or the converted image.

Other aspects of the present invention will be illustrated in the following embodiments.

Further features of the present invention will become apparent from the following description of exemplary embodiments with reference to the attached drawings.

### BRIEF DESCRIPTION OF DRAWINGS

FIG. 1 is a diagram illustrating the functional configuration of an image processing apparatus employing a method having a small difference between real images and CGs.

FIG. 2 is a diagram illustrating the functional configuration of an image processing apparatus employing a method having a low delay only for real images.

FIG. 3 is a diagram illustrating the functional configuration of an image processing apparatus according to a first embodiment.

FIG. 4 illustrates a layer composition in a conventional arithmetic unit in the first embodiment.

FIG. 5 illustrates an image synthesized by a conventional processing unit in the first embodiment.

FIG. 6 illustrates a layer composition of an arithmetic unit a low delay method in the first embodiment.

FIG. 7 illustrates an image synthesized by a processing unit of a low delay method in the first embodiment.

FIG. 8 is a diagram illustrating the functional configuration of an image processing apparatus according to a second embodiment.

FIG. 9 is a diagram illustrating the hardware configuration of the image processing apparatus according to the first embodiment.

### DESCRIPTION OF EMBODIMENTS

Preferable embodiments of the present invention will be described in detail hereinbelow with reference to the drawings. It is to be understood that the configurations described in the embodiments are typical examples and the scope of the present invention is not limited to the specific configurations.

### First Embodiment

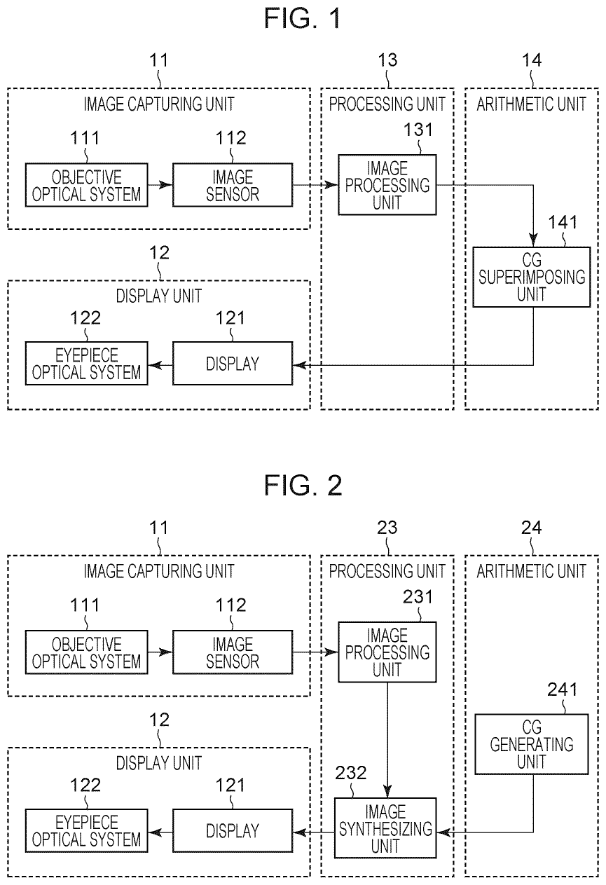

FIG. 1 is a diagram illustrating the functional configuration of an image processing apparatus employing a method having a small difference between real images and CGs. Referring to FIG. 1, the procedure of signal processing of a conventional video see-through method will be described.

In FIG. 1, reference sign 111 denotes an objective optical system that captures real images of the outside world as light, and 112 denotes an image sensor that converts the real images from light signals to electrical signals, which constitute an image capturing unit 11. The image capturing unit 11 may separately include the objective optical system 111 and the image sensor 112 or may be an integrated camera module.

Reference sign 121 denotes a display that converts the electrical signals of images to light signals, and 122 denotes an eyepiece optical system that delivers the image light to the eyes of the HMD user, which constitute a display unit 12. The display 121 is a flat-plate image display element, such as an organic electroluminescence (EL) display or a liquid crystal display.

Reference sign 131 denotes an image processing unit constituting a processing unit 13 that develops RAW data obtained by the image sensor 112 and that adjusts the image quality. Transmission from the image capturing unit 11 to the processing unit 13 has a relatively low delay, and the image processing unit 131 performs relatively low delay processing in the entire system. The processing unit 13 may be in the same HMD as the image capturing unit 11 and the display unit 12 or may be outside the HMD including the image capturing unit 11 and the display unit 12.

Reference sign 141 denotes a CG superimposing unit that constitutes an arithmetic unit 14 and that calculates the position and orientation information of the HMD, renders a virtual image (CGs) based on the position and orientation information, receives a real image processed by the image processing unit 131, and generates an image in which the CGs are superimposed on the real image. To calculate the position and orientation information of the HMD, there are many methods, such as a method using a real image transmitted from the processing unit 33, a method using an image of a separate system from the display, and a method of calculation from acceleration, angular velocity, or another sensor, details of which will be omitted

However, the calculation of position and orientation mainly from images needs many processes, which requires many system resources or much execution time, resulting in delay. The process of rendering CGs also needs many processes depending on the amount of data and quality of the CGs, which is also responsible for the delay. Thus, the CG superimposing unit 141 causes a delay due to a large number of calculations, and the transmission from the processing unit 13 to the arithmetic unit 14 causes a relatively long delay. Accordingly, processing through the arithmetic unit 14 causes a relatively long delay in the entire system. Here, the processing unit 13 and the arithmetic unit 14 are separate for the convenience of description. In some embodiments, the processing unit 13 and the arithmetic unit 14 are located in the same place. Alternatively, the arithmetic unit 14 may be separate from the service position of the HMD, such as on cloud, and there may be a significant delay due to transmission.

Although it is described that CGs are rendered and superimposed in the above, the CGs may be 3D data handled in computer-aided design (CAD) or similar applications or images that are copies of a personal computer (PC) screen displayed on a conventional display.

The image capturing unit 11 converts an image of the outside world beyond the line of sight of the HMD user from light to electrical signals, the processing unit 13 processes the image to improve the image quality, and the arithmetic unit 14 superimposes CGs seen from the position and orientation of the HMD user on the real image. Display control to display the synthesized image on the display unit 12 in the HMD allows the HMD user to observe the CGs together with the real image of the outside world.

The conventional video see-through method has the advantages of being capable of displaying CGs with high positional accuracy with respect to the real image and having no delay difference between the real image and the CGs. However, the conventional video see-through method causes a delay in transmission between the paths and processing, in particular, a delay through the arithmetic unit 14, resulting a significant delay in the image observed by the HMD user.

FIG. 2 is a diagram illustrating the functional configuration of an image processing apparatus employing a method having a low delay only for real images. Referring to the image capturing unit and the display unit in FIG. 2, the procedure of signal processing of the video see-through method in which only real images have a low delay.

Since the image capturing unit 11 and the display unit 12 in FIG. 2 are the same as in FIG. 1, descriptions will be omitted.

Reference sign 231 denotes an image processing unit that performs the same processing as the image processing unit 131 but outputs the real image not to the arithmetic unit 24 but to an image synthesis unit 232 in the processing unit 23.

Reference sign 241 denotes a CG generation unit that renders CGs after calculating the position and orientation of the HMD like the CG superimposing unit 141 and constitutes an arithmetic unit 24. However, after the rendering, the CG generation unit 241 does not combine the CGs with the real image but outputs the CGs and chromakey information or alpha-cannel information for synthesis to the processing unit 23. The CG generation unit 241 also requires many operations, taking much time for the processing with the arithmetic unit 24, similarly resulting in a relatively large delay in the entire system. Here, the processing unit 23 and the arithmetic unit 24 may be located in the same place or different places, as described above.

Since the real image captured by the image capturing unit 11 is displayed on the display unit 12 after being turned back at the processing unit 23 having a low delay, the real image to be observed by the HMD user can be displayed with the lowest possible delay. On the other hand, since it takes much time to calculate the position and orientation of the HMD to generate CGs, to render the CGs, and to transmit the CGs, there is no significant difference from the conventional video see-through method in the delay of the synthesized CG image. This raises new issues, such as a difference in delay time between the real image displayed with a low delay and the CGs with a high delay.

As has been described above, the conventional video see-through method has the issue of a high delay although no time delay difference is made between a real image and CGs, while the video see-through method in which only the real image has a low delay causes a time delay difference between a real image and CGs. Accordingly, allowing the HMD user to select the above methods depending on the use case or use environment improves the convenience of the HMD.

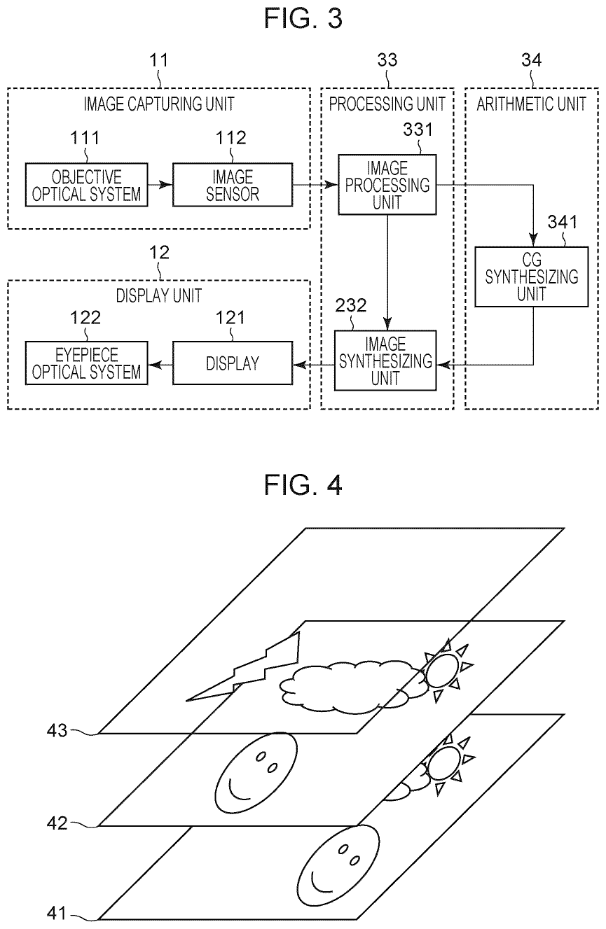

FIG. 3 is a diagram illustrating the functional configuration of an image processing apparatus according to a first embodiment. The procedure of signal processing performed by an image capturing unit and a display unit will be described with reference to the drawing.

Since the image capturing unit 11 and the display unit 12 in FIG. 3 are the same as in FIG. 1, descriptions will be omitted.

Reference sign 331 in FIG. 3 denotes an image processing unit that performs the same processing as the image processing unit 131 but outputs the real image to both the arithmetic unit 14 and the image synthesis unit 232 in the processing unit 33. The images output to the image synthesis unit 232 and the arithmetic unit 14 may be exactly the same or may be partly different in resolution or compression, for example. The original image is a real image that makes up part of the field of view of the HMD user captured by the image capturing unit 11.

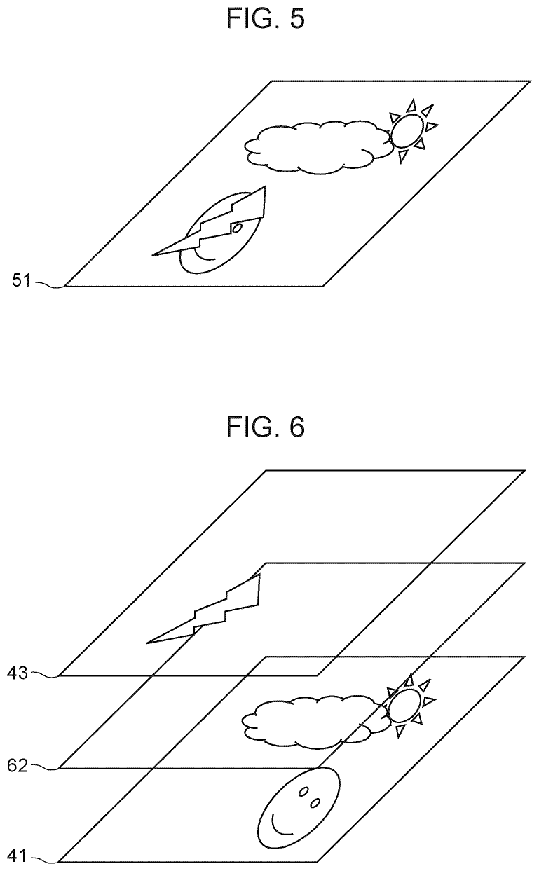

Reference sign 341 denotes a CG synthesizing unit 341, which is the same as the CG superimposing unit 141 in rendering CGs after calculating the position and orientation of the HMD and constitutes an arithmetic unit 34. However, after the rendering, whether to superimpose CGs on the real image or output CGs and chromakey information or alpha-channel information for synthesis to the processing unit 33 is selected by the user. The layer composition of the real image and CGs will be described below with reference to FIGS. 4 to 7. The CG synthesizing unit 341 also requires many calculations, which takes much time to pass through the arithmetic unit 34, resulting in a relatively large delay in the entire system. Here, the processing unit 33 and the arithmetic unit 34 may be located in the same place or different places, as described above.

The real image captured by the image capturing unit 11 may be displayed on the display unit 12 after being turned back at the processing unit 33 having a low delay or without a time delay difference from the CGs via the arithmetic unit 34. For the switching, there is no change in the procedure and configuration of the signal processing illustrated in FIG. 3, and changing the real image to be combined by the CG synthesizing unit 341 is simply required. This configuration simplifies the composition of the image capturing unit 11, the display unit 12, and the processing unit 33 and allows for using them without switching the operation modes, etc.

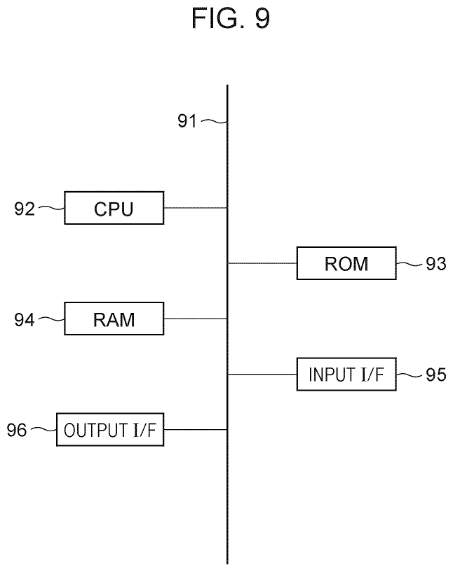

Next, the hardware configuration of the image processing apparatus including the processing unit 33 and the arithmetic unit 34 will be described. FIG. 9 is a block diagram illustrating the hardware configuration of the image processing apparatus of this embodiment. In FIG. 9, a central processing unit (CPU) 92 controls the connected devices via a bus 91 as a whole. The CPU 92 reads and executes commands and programs stored in a read-only memory (ROM) 93. An operating system (OS), processing programs, and device drivers according to this embodiment are stored in the ROM 93, which are temporarily stored in a random-access memory (RAM) 94 and suitably executed by the CPU 92.

An input interface (I/F) 95 receives input signals from an external device, such as the image capturing unit 11, in a format that can be processed by the image processing apparatus. An output I/F 96 outputs output signals in a format that can be processed by an external device, such as the display unit 12.

Next, the layer composition of an image synthesized by the image synthesis unit 232 of this embodiment will be described with reference to FIGS. 4 to 7.

FIG. 4 illustrates a layer composition before synthesis in a conventional video see-through method. Reference sign 41 denotes an image output to the image synthesis unit 232, the image being a real image captured by the image capturing unit 11 and processed by the image processing unit 331. The image 41 is used as the background image in the lowermost layer of the layer composition.

Reference sign 42 denotes an image output to the arithmetic unit 34, the image being a real image captured by the image capturing unit 11 and processed by the image processing unit 331. The image 42 is used as the background image in combining with CGs and positioned as an intermediate layer in the entire system.

Assuming that the image represented by a human face contained in the image 41 and the image 42 is moving from the left to right in real time, the human face in the image 41 is at the right end of the screen, but the human face in the image 42 is near the center of the screen. This is because, in the background image 41 processed by the processing unit 33, the human face has already moved to the right in the screen because of a small delay in transmission and processing, while in the background image 42 passing through the arithmetic unit 34, the human face has not moved due to a delay in transmission and processing. In contrast, the almost stationary cloud and sun do not differ in position although there is a time delay difference between the image 41 and the image 42.

Reference sign 43 denotes a CG image generated by the CG synthesizing unit 341 and positioned at the uppermost layer of the layer composition. The CG image 43 at the arithmetic unit 34 is delayed because the CGs are rendered after the position and orientation of the HMD is calculated. The portion other than the CG image of lightning is made up by chromakey information for chromakey synthesis or alpha-cannel information for alpha synthesis.

The image output from the arithmetic unit 34 to the processing unit 33 is an image in which the background image 42 passing through the arithmetic unit 34 and the CG image 43 generated at the arithmetic unit 34 are combined. Because of the presence of the background image 42 passing through the arithmetic unit 34, chromakey information or alpha-channel information is not normally output but may be added to part of the image as a means for image expression, or the transparency may be controlled.

FIG. 5 illustrates a synthesized image in the conventional video see-through method.

All the layers are combined by the image synthesis unit 232 of the processing unit 33. However, if the output from the arithmetic unit 34 does not contain chromakey information or alpha-channel information, the real image presented to the HMD user is the background image 42 passing through the arithmetic unit 34 which has a delay.

The background image 41 at the processing unit 33 having a small delay is output from the image processing unit 331 to the image synthesis unit 232 but results in being unused.

As a result of the processing, the real image and the CGs having a large delay are displayed on the HMD although there is no difference in delay time therebetween. For this reason, an image not different from the image using the conventional video see-through method is presented to the HMD user. In an image 51 sent to the display unit 12 with the conventional method in this description, the CG lightning is superimposed on the real image of the human face.

FIG. 6 illustrates a layer composition before synthesis in the video see-through method in which only real images have a low delay. The image 41 and the image 43 do not differ from FIG. 4, and descriptions will be omitted.

Reference sign 62 denotes a converted image converted by the arithmetic unit 34. The image 62 is an intermediate layer in which the real image expressed as the background image 42 passing through the arithmetic unit 34 is normally drawn as described above. If no real image is acquired from the processing unit 33 or if a real image is transmitted from the processing unit 33 to the arithmetic unit 34 but is not used, the image 62 converted by the arithmetic unit 34 contains nothing. The image 62 converted by the arithmetic unit 34 may be a real image transmitted from the processing unit 33 to the arithmetic unit 34, where the transparency of the real image is controlled, for example, part or the whole of the real image is made transparent, and may be added as alpha-channel information. The image 62 converted by the arithmetic unit 34 may be a real image transmitted from the processing unit 33 to the arithmetic unit 34, where the color information of part or the whole of the real image is converted to a color representing chromakey information, and may be added as chromakey information. With such means, the image 62 converted by the arithmetic unit 34 is partly or entirely converted and combined with the CG image 43 at the arithmetic unit 34, and output from the arithmetic unit 34 to the processing unit 33.

Here, the image expressed as the human face in the image 41 moves from the left to right in real time, and the cloud and sun are stationary, as described above.

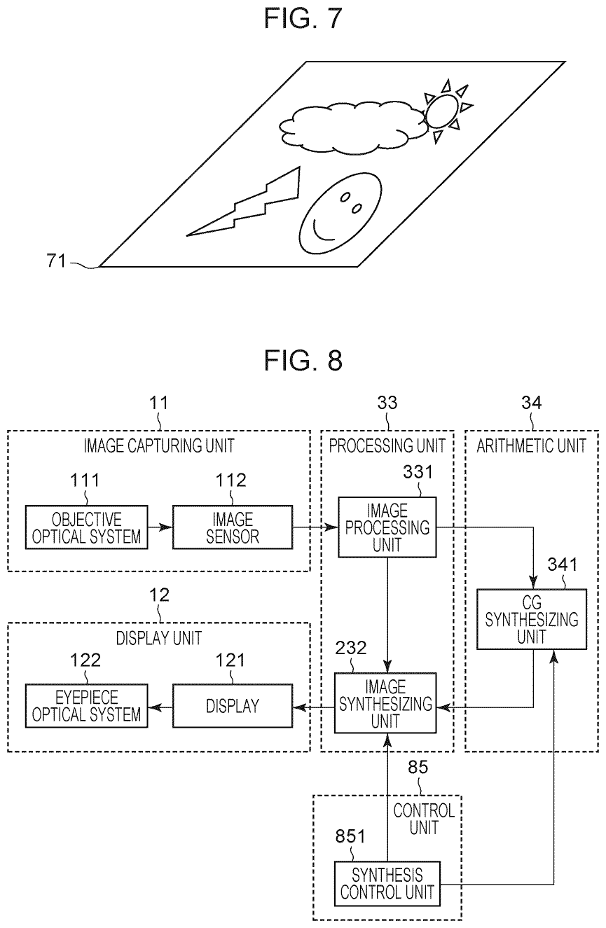

FIG. 7 illustrates a synthesized image in the video see-through method having a small delay in real image.

All the layers are finally combined by the image synthesis unit 232 of the processing unit 33. If the whole of the image 62 to be converted by the arithmetic unit 34 is made transparent, the entire image other than the CG image is transparent. For this reason, the background image 41 at the processing unit 33 is combined as the background, and the real image presented to the HMD user is the background image 41 at the processing unit 33 having a small delay.

As a result of the processing, an image having a delay time difference between the real image and the CGs is displayed on the HMD although the real image has a small delay. For this reason, an image not different from the image using the video see-through method in which only the real image has a low delay is presented to the HMD user. In an image 71 sent to the display unit 12 using the method in which only the real image has a low delay, the real image of the human face has already moved to the right end with a small delay from the real time, and the lightning CG is not superimposed on the human face.

As has been described above, this embodiment outputs a real image from the image processing unit 331 to the image synthesis unit 232 and the CG synthesizing unit 341, and the layer structure of the CG and the real image is determined in advance. This allows for controlling the delay time of the real image displayed on the HMD only by changing the real image with the arithmetic unit 34 without exerting influence on the configuration and control of the image capturing unit 11, the display unit 12, and the processing unit 33.

### Second Embodiment

FIG. 8 is a diagram illustrating the functional configuration of an image processing apparatus according to a second embodiment. Referring to FIG. 8, the procedure of signal processing of image capturing and display according to the second embodiment will be described.

In FIG. 8, the image capturing unit 11, the display unit 12, the processing unit 33, and the arithmetic unit 34 are the same as in the first embodiment, and descriptions will be omitted. In FIG. 8, a synthesis control unit 851 of a control unit 85 controls a method of synthesis for the image synthesis unit 232 of the processing unit 33 and a CG synthesizing unit 341 of the arithmetic unit 34.

The first embodiment allows selecting the conventional video see-through method having no delay time difference between the real image and CGs or a method in which only the real image has a low delay only by changing the real image at the arithmetic unit 34. The second embodiment allows selecting the methods manually or automatically by adding the control unit 85.

If the HMD user wants to view only a real image having a low delay, the synthesis control unit 851 instructs the image synthesis unit 232 to output only the background image 41 at the processing unit 33 illustrated in FIGS. 4 and 6 to the display unit 12. Alternatively, images other than the background image 41 at the processing unit 33 may be made transparent by the image synthesis unit 232, or all the images including CGs may be made transparent by the CG synthesizing unit 341.

If the HMD user wants to view only CGs and a stationary background image, only the CGs and the stationary background image are output to the display unit 12 by the synthesis control unit 851 instructing the CG synthesizing unit 341 to convert the image 62 to be converted by the arithmetic unit 34 to the stationary image. Alternatively, even if the image synthesis unit 232 does not combine and discard the background image 41 at the processing unit 33, only the CGs and the stationary background image are output to the display unit 12.

Thus, the control unit 85 issues instructions to the processing unit 33 or the arithmetic unit 34, or to the processing unit 33 and the arithmetic unit 34 according to the user's intention, thereby enabling control of the synthesis image.

The image signals communicated between the processing unit 33 and the arithmetic unit 34 may be interrupted because of transmission or processing, causing problems in comfortable HMD viewing and listening. In this case, the synthesis control unit 851 instructs the image synthesis unit 232 to output only the background image 41 processed at the processing unit 33 to the display unit 12, enabling comfortable viewing of a real image having a low delay.

Alternatively, the background image 41 processed by the processing unit 33 and the background image 42 passing through the arithmetic unit 34 illustrated in FIG. 4 may be compared. This allows, when the delay time exceeds a set threshold, viewing and listening using the video see-through method in which only real images have a low delay by the synthesis control unit 851 instructing the CG synthesizing unit 341 to form the image 62 converted by the arithmetic unit 34 as illustrated in FIG. 6.

Thus, the control unit 85 instructs the processing unit 33 or the arithmetic unit 34 or instructs the processing unit 33 and the arithmetic unit 34 depending on the situation of transmission and processing, enabling control of a synthesis image.

### Other Embodiments

Embodiments of the present invention can also be realized by one or more processors of a computer of a system or apparatus that reads and executes programs for achieving one or more functions of the embodiments supplied via a network or a storage medium or by a circuit for achieving one or more functions (for example, application specific integrated circuit (ASIC)).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to an aspect of the present invention, a method for combining a real image with a virtual image can be changed with a simple configuration.

1. An image processing apparatus comprising:
at least one processor that functions as:
an acquisition unit configured to acquire a real image captured by an image capturing device and output the real image;
a generation unit configured to receive the real image output from the acquisition unit, generate a virtual image, output the virtual image, and output the received real image or a converted image of the real image;
a synthesis unit configured to combine the real image output from the acquisition unit, the virtual image output from the generation unit, and the real image or the converted image output from the generation unit; and
a display control unit configured to display an image synthesized by the synthesis unit on a display device,
wherein the generation unit changes a delay time of the real image in the image displayed on the display device depending on whether to output the real image or the converted image.

2. A method of image processing, comprising:
acquiring a real image captured by an image capturing device and outputting the real image;
generating including receiving the real image output in the acquiring, generating a virtual image, outputting the virtual image, and outputting the received real image or a converted image of the real image;
combining the real image output in the acquiring, the virtual image output in the generating, and the real image or the converted image output in the generating; and
displaying an image synthesized in the combining on a display device,
wherein the generating includes changing a delay time of the real image in the image displayed on the display device depending on whether to output the real image or the converted image.

3. The method of image processing according to claim 2, wherein, the combining includes combining the virtual image output in the generating, the real image or the converted image output in the generating, and the real image output in the acquiring in this order.

4. The method of image processing according to claim 2, wherein the generating includes changing a delay time of the real image in the image displayed on the display device based on whether the real image is output or not

5. The method of image processing according to claim 2, wherein the generating includes outputting, as the converted image, an image in which transparency of part or whole of the received real image is converted.

6. The method of image processing according to claim 5, wherein the generating includes outputting, as the converted image, an image in which part or the whole of the received real image is made transparent.

7. The method of image processing according to claim 2, wherein the generating includes outputting, as the converted image, an image in which color of part or whole of the received real image is converted.

8. The method of image processing according to claim 7, wherein the generating includes outputting, as the converted image, an image in which the color of part of the whole of the received real image is converted to a color representing chromakey information.

9. The method of image processing according to claim 2, wherein the generating includes switching between outputting the real image or outputting the converted image based on user instructions.

10. The method of image processing according to claim 2, further comprising controlling whether to output the real image or the converted image in the generating based on a state of the image output in the generating.

11. The method of image processing according to claim 2, wherein the acquiring includes adjusting and outputting the real image acquired from the image capturing device.

12. A non-transitory computer-readable storage medium storing a program that causes a computer to execute a method of image processing, the method comprising:
acquiring a real image captured by an image capturing device and outputting the real image;
generating including receiving the real image output in the acquiring, generating a virtual image, outputting the virtual image, and outputting the received real image or a converted image of the real image;
combining the real image output in the acquiring, the virtual image output in the generating, and the real image or the converted image output in the generating; and
displaying an image synthesized in the combining on a display device,
wherein the generating includes changing a delay time of the real image in the image displayed on the display device depending on whether to output the real image or the converted image.
